(19) United States
(12) Patent Application Publication
(10) Pub. No.: US 2002/0079469 A1
(43) Pub. Date: Jun. 27, 2002

(54) Product tracking during grading

(76) Inventor: Hamish Alexander Nigel Kennedy, (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/027,344

(22) Filed: Dec. 20, 2001

(30) Foreign Application Priority Data
Dec. 21, 2000 (NZ) 509104

(51) Int. Cl. G01N 21/86

(52) U.S. Cl. 250/559.4

(57) ABSTRACT

The characteristics of a product such as fruit are determined by analysing light reflected from or transmitted through the product. A tracking means which in one embodiment has an oscillating mirror and in another a light switching means enables a product to be tracked during its movement. Radiation other than that in the visible spectrum may be used.

### FIELD OF THE INVENTION

The present invention relates to improvements in and relating to a method and/or apparatus for product tracking during grading.

The present invention will be particularly described for simplicity only in respect of the grading of products such as fruit. It will be appreciated, however, that the present invention has application throughout the area of grading. Additionally, the invention, again, for simplicity, will be described in respect of the use of “light” for the purposes of grading. It will be appreciated, however, that the present invention could in other embodiments utilise radiation other than that in the visible spectrum and the term “light” is to be construed as having this broad meaning.

In the grading of products such as fruit, a problem has been to provide the ability to measure the product properties at multiple points on the product surface. Clearly, if colour is being detected, then consistent colour across the surface may be important as will be the presence of bruising or other damage at any point on the surface. To achieve the multiple point detection of the properties, typically in the case of fruit, it will be rotated as it moves under a detector. However, as the fruit will be rotating under a detector only for a relatively short period of time, only a relatively small area of its surface can be scanned. Typically, a fruit would only be in position for measurement of its properties for some fifteen to twenty-five percent of the time. The position can be improved using multiple detectors so that with the fruit being rotated a respective detector can be analysing a specific area of the fruit.

However, none of the options currently available have proved entirely satisfactory.

A typical detector/analyser used for this purpose is complex and expensive so the use of a large number of them in a system could be prohibitively expensive.

One solution, of course, would be to move the analyser and the detector together with the fruit, but clearly this is unlikely to be practical having to dedicate a particular detector to an individual fruit, as well as the problem of moving what can be a fairly heavy analyser and detector to synchronise with the typically rapid movement of the fruit.

For simplicity the term “analyser” will be used to cover apparatus such as a spectrometer which is adapted to both detect a required signal and then analyse what has been detected.

### OBJECTS OF THE INVENTION

It is, thus, an object of the present invention to provide a method and/or apparatus for enabling a multiple point measurement of the properties of a product which will overcome or at least ameliorate problems in such methods and/or apparatus to the present time, or which at least will provide the public with a useful choice.

Further objects of the invention will become apparent from the following description.

### SUMMARY OF THE INVENTION

According to one aspect of the present invention, there is provided a method of enabling a multiple point measurement of the properties of a moving product, said method including:

(i) providing at least one source of light (as herein defined);

(ii) providing a tracking means adapted to track a respective one of said products during movement thereof so that characteristics of said product may be determined using light reflected from and/or transmitted by said product during its movement.

Preferably, the step of providing the tracking means of the paragraph immediately above may include providing an oscillating mirror assembly to follow said product during its movement so as to direct light reflected and/or transmitted by the product to an analysing means.

Preferably, in another embodiment, the step of providing the tracking means may include a plurality of mirrors rotatable about a common axis to enable the movement of the products to be followed.

Preferably, in a further embodiment a plurality of sources of light are provided and adapted to enable a sequential tracking of a particular product.

Preferably, in a particular embodiment, a single source of light is provided and wherein a switching means is also provided to enable said single source of light to provide multiple light sources adapted to track the movement of the product.

Preferably, in one embodiment, the products are adapted to be rotated during their movement or to be maintained non-rotatable.

According to a further aspect of the present invention, a method of product tracking during grading is substantially as herein described with reference to any one of the embodiments of the invention of the accompanying drawings.

According to a still further aspect of the present invention, an apparatus for tracking of moving products during grading includes:

(i) at least one source of light (as herein defined);

(ii) tracking means to track a respective product during movement thereof;

(iii) analysing means to receive light reflected and/or transmitted from the respective product and analyse the characteristics thereof.

Preferably, the apparatus of the paragraph immediately above may include said tracking means with a mirror system enabling a mirror or a respective mirror to direct light onto a respective product during its movement.

Preferably, the mirror system of the paragraph immediately above may include a plurality of mirrors rotatable about a common axis or a single mirror adapted to oscillate and follow a particular product.

Preferably, the apparatus of either of the two paragraphs immediately above may include a single source of light and further includes switching means to effectively provide a plurality of sources of light to illuminate one of said products as it moves.

Preferably, in an alternative embodiment, a plurality of sources of light may be provided to sequentially direct light onto a particular product as it moves relative to a particular source of light.

According to a further aspect of the present invention, an apparatus for product tracking during grading is substantially as herein described with reference to any one of the embodiments of the accompanying drawings.

Further aspects of this invention, which should be considered in all its novel aspects will become apparent from the following description given by way of example of possible embodiments thereof and with reference to the accompanying drawings.

### BRIEF DESCRIPTION OF THE DRAWINGS

FIG. 1: shows very diagrammatically an apparatus according to one possible embodiment of the invention;

FIG. 2: shows very diagrammatically an apparatus according to a further possible embodiment of the invention;

FIG. 3: shows very diagrammatically an apparatus according to a still further possible embodiment of the invention;

FIG. 4: shows very diagrammatically an apparatus according to yet a still further possible embodiment of the invention;

### DESCRIPTION OF THE INVENTION

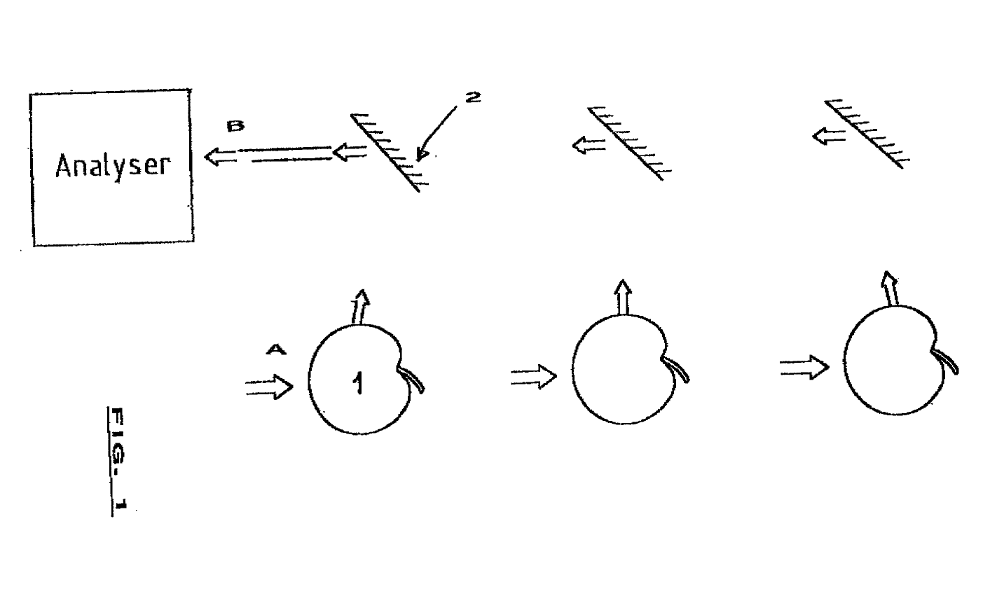

Referring to FIG. 1, a product 1 is shown moving in a direction indicated by arrow A, typically in the case of fruit, this being on a roller-type conveyor. The movement of the product 1 is shown being tracked by a mirror arrangement 2 so that as the product 1 moves, the light incident on it is still being captured by the mirror 2 to be reflected as indicated by the arrows B to a suitable detector/analyser such as a spectrometer.

It is envisaged that the mirror arrangement 2 could include a single oscillating mirror which will follow the product 1 to direct the light to the detector/analyser as the product moves and then return to the starting position so as to track with the next product. Alternatively, it is envisaged that a number of mirrors could be provided to rotate about a common axis to provide the same effect of tracking the product 1 during its movement.

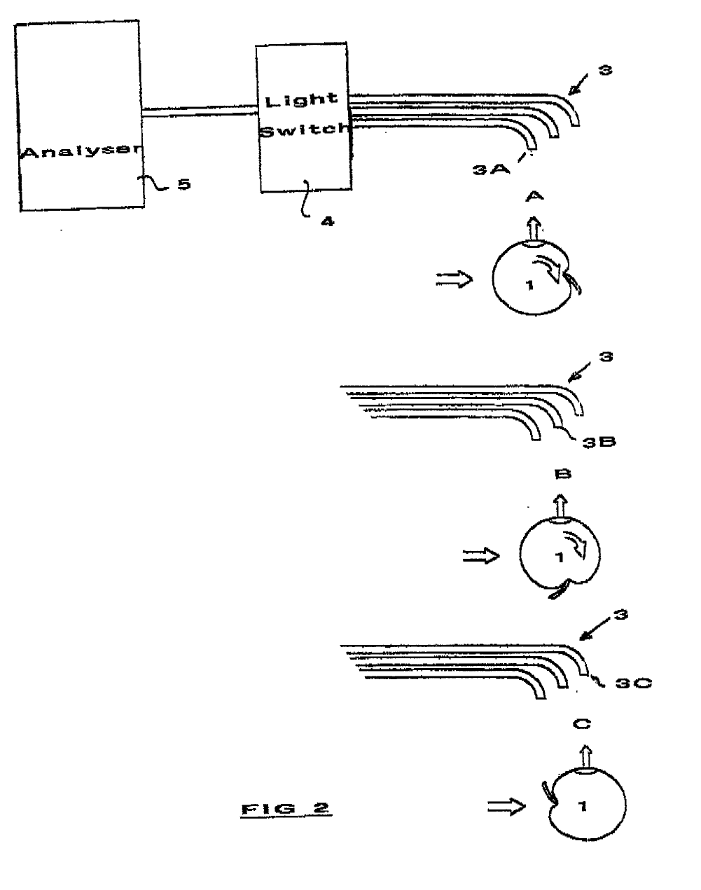

Referring to FIG. 2, the product 1 is shown very diagrammatically in three positions having rotated as it moves down the right hand side of the page. There are multiple light collectors indicated by arrow 3 along the path of travel of the product 1 so that in the first position, the light being reflected from the product 1 is being captured by the light collector 3A, in the second position, the light reflected is being captured by light collector 3B and in position C, the light reflected is being captured by light collector 3C, etc. The multiple collectors are shown connected with a light switch 4 which in turn is shown connected with an analyser 5. The light collectors 3 may suitably be fibre optic cables and/or lenses and/or mirrors with one or more light switches and suitably a single analyser 5.

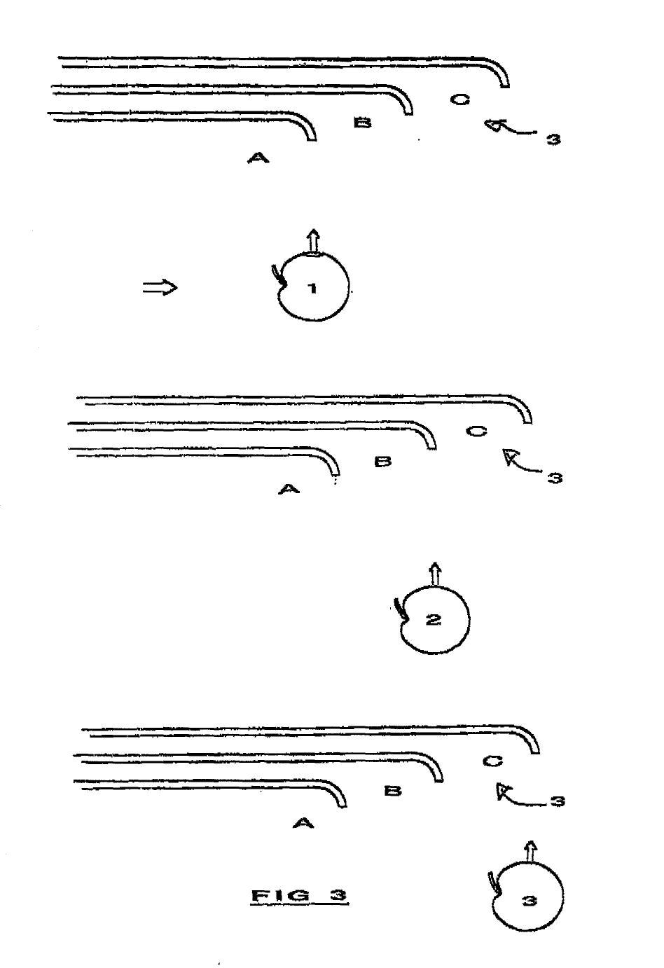

The multiple collectors 3 will suitably be positioned so that during the passage of the product (which may or may not be rotated), a particular collector will be at the optimum viewing position to receive the reflected light. In an alternative embodiment as shown in FIG. 3, the light collectors 3 may receive light in any particular sequence depending on which collector was at the optimum position and a suitable computer program could then determine which product was responsible for the reflected light at any instant. So in FIG. 3, the computer program would be recognising that it was receiving light from product 1, light from collector 3B from product 2 and light from product 3 from collector 3C with the sequence then restarting with the next product providing reflected light for collector 3A. It is envisaged that the arrangement of FIG. 3 may be more convenient for physical implementation.

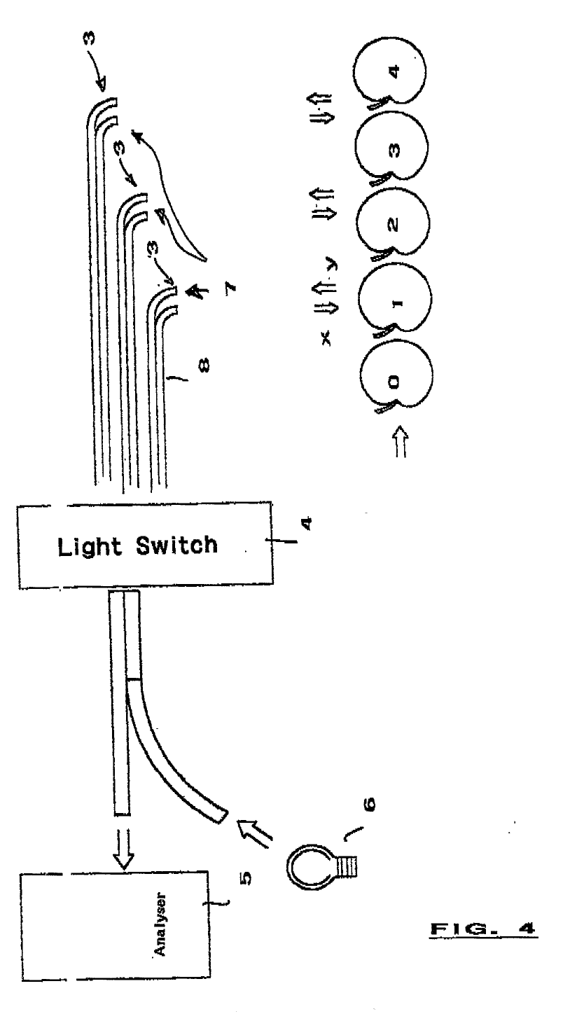

Referring to FIG. 4, the same reference numerals being used where appropriate, a single light source 6 is shown providing a light beam which is converted by a light switch 4 to provide a plurality of light sources 7 through fibre optic cables 8, or alternatively, individual light sources could be provided for each of the detecting areas. The transmitted and reflected light is indicated by arrows X,Y at each of the positions, so that the characteristics of a particular product can be determined as it passes a particular position with the reflected light being passed through the fibre optic cables to the analyser 5.

Once again, the products 0, 1, 2, 3, 4 are shown moving transversely across the page, but without any rotation as they move. Although, in some embodiments of the invention, rotation will be part of a horizontal movement, in some instances, it may be appropriate for there to be no rotational movement in order to provide a measurement of the same area for a longer duration to be carried out. Additionally, non-rotation can enable a measurement to be taken from particular areas such as on the equator and the poles of a particular product.

Although the embodiments of the invention have been illustrated utilising reflected light, it is to be understood that the other embodiments may utilise additionally, or alternatively, light transmitted through the products. In this regard, the quality of information available from transmitted light may be better than that from reflected light especially in respect of certain characteristics.

If transmitted light is utilised then the positioning of the collectors (3), or additional collectors, would be adjusted accordingly from that shown in the drawings.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

I claim:

1. A method of enabling a multiple point measurement of the properties of a moving product, said method including:
(i) Providing at least one source of light (as herein defined);
(ii) Providing a tracking means adapted to track a respective one of said products during movement thereof so that characteristics of said product may be determined using light reflected from and/or transmitted by said product during its movement.

2. A method as claimed in claim 1 wherein the said tracking means includes an oscillating mirror assembly to follow said product during its movement so as to direct and/or receive light reflected it and/or transmitted it by the product to an analysing means.

3. A method as claimed in claim 1 where said tracking means includes a light switching means and multiple collectors provided along the path of movement of the product.

4. A method as claimed in 2 wherein said mirror assembly includes a plurality of mirrors rotatable about a common axis to enable the movement of the products to be followed.

5. A method as claimed in claim 1 including a plurality of said sources of light adapted to enable a sequential tracking of a particular said product.

6. A method as claimed in claim 1 including a single source of light and a switching means adapted to enable said single source of light to provide multiple light sources adapted to track the movement of the product.

7. A method as claimed in claim 1 wherein the products are adapted to be rotated during their movement.

8. An apparatus for tracking of moving products during grading including:
(i) At least one source of light (as herein defined);
(ii) Tracking means to track a respective product during movement thereof;
(iii) Analysing means to receive light reflected and/or transmitted from the respective product to analyse the characteristics thereof.

9. Apparatus as claimed in claim 8 wherein said tracking means includes a mirror system which enables a mirror or a respective mirror to direct and/or receive light onto/from a respective product during its movement.

10. Apparatus as claimed in claim 9 wherein said mirror system includes an oscillating mirror assembly to follow said product during its movement so as to direct and/or receive light reflected and/or transmitted by the product to said analysing means.

11. Apparatus as claimed in claim 8 wherein said tracking means includes a plurality of mirrors rotatable about a common axis to enable the movement of the products to be followed.

12. Apparatus as claimed in claim 11 including a single said source of light and further includes switching means operatively connected with said source of light to effectively provide a plurality of sources of light to illuminate one of said products as it moves.

13. Apparatus as claimed in claim 8 wherein said tracking means includes a light switching means and multiple collectors provided along the path of movement of the product.

14. Apparatus as claimed in claim 8 including a plurality of said sources of light to sequentially direct light onto a particular product as it moves relative to a particular source of light.
